(19) United States
(12) Patent Application Publication
(10) Pub. No.: US 2026/0018631 A1
(43) Pub. Date: Jan. 15, 2026

(54) FUEL-CELL EXHAUST SYSTEM, FUEL CELL SYSTEM AND METHOD FOR REDUCING THE HYDROGEN CONTENT IN FUEL-CELL EXHAUST GAS

(71) Applicant: Purem GmbH, Neunkirchen (DE)

(72) Inventors: Jochen Hammer, Stuttgart (DE); Tobias Lehr, Esslingen (DE)

(21) Appl. No.: 19/264,399

(22) Filed: Jul. 9, 2025

(30) Foreign Application Priority Data
Jul. 9, 2024 (DE) 10 2024 119 423.5

(51) Int. Cl. H01M 8/04119; H01M 8/04111; H01M 8/0432

(52) U.S. Cl. CPC H01M 8/04164; H01M 8/04111; H01M 8/0435; H01M 2250/20

(57) ABSTRACT

A fuel-cell exhaust system for a fuel cell system includes a water separation arrangement for separating water contained in fuel-cell exhaust gas and a hydrogen catalyst arrangement for catalytically converting hydrogen contained in the fuel-cell exhaust gas downstream of the water separation arrangement. The fuel-cell exhaust system is especially suited for a fuel cell system in a vehicle.

### CROSS-REFERENCE TO RELATED APPLICATIONS

This application claims priority of German patent application no. 10 2024 119 423.5, filed Jul. 9, 2024, the entire content of which is incorporated herein by reference.

### TECHNICAL FIELD

The present disclosure relates to a fuel-cell exhaust system, to a fuel cell system containing such a fuel-cell exhaust system and to a method for reducing the hydrogen content in the fuel-cell exhaust gas discharged by a fuel cell of a fuel cell system.

### BACKGROUND

When generating electrical energy in a fuel cell system, for example constructed with one or more PEM fuel cells, water is produced, in particular in the cathode area. This is generally carried along as water vapor in the cathode exhaust gas leaving the cathode area, which substantially also provides the fuel-cell exhaust gas to be discharged to the environment, and is discharged to the environment via a fuel-cell exhaust system. Especially at comparatively low ambient temperature, when fuel-cell exhaust gas with a high concentration of water vapor is discharged into the ambient air, mist is produced as a result of water condensing out due to the spontaneous lowering of the temperature of the fuel-cell exhaust gas when it comes into contact with the ambient temperature. This may impair visibility in the vicinity of a vehicle equipped with such a fuel cell system and may also cause ice to form on the ground in the area of a vehicle equipped with such a fuel cell system. In such fuel cell systems it is also possible for example during or after carrying out purging processes that the fuel-cell exhaust gas discharged to the environment contains an excessively high proportion of hydrogen (H₂).

### SUMMARY

It is an object of the present disclosure to provide a fuel-cell exhaust system, a fuel cell system constructed therewith and a method for reducing the hydrogen content in fuel-cell exhaust gas with which the formation of a large amount of mist when the fuel-cell exhaust gas is discharged into the environment is counteracted by a reduced discharge of hydrogen with the fuel-cell exhaust gas while using a structurally simple configuration.

According to a first aspect of the present disclosure, this object is achieved by a fuel-cell exhaust system for a fuel cell system, in particular in a vehicle, including:
a water separation arrangement for separating water contained in fuel-cell exhaust gas;
a hydrogen catalyst arrangement for catalytically converting hydrogen contained in the fuel-cell exhaust gas downstream of the water separation arrangement.

The fuel-cell exhaust system of a construction according to the disclosure uses the heat released during the catalytic conversion of the molecular hydrogen (H₂) in the hydrogen catalyst arrangement for heating the hydrogen-depleted fuel-cell exhaust gas flowing through or leaving the hydrogen catalyst arrangement. By heating the hydrogen-depleted fuel-cell exhaust gas, the water vapor uptake capacity of the fuel-cell exhaust gas increases significantly, so that, even when water or water vapor is produced during this catalytic conversion of hydrogen with molecular oxygen (O₂) contained in the fuel-cell exhaust gas, the relative humidity of the fuel-cell exhaust gas leaving the hydrogen catalyst arrangement is lowered in comparison with the fuel-cell exhaust gas discharged from a fuel cell in such a way that, when this fuel-cell exhaust gas is discharged even into comparatively cold ambient air, the spontaneous reaching of a saturation level of 100%, and consequently precipitation of mist, can be largely prevented. This also contributes to ensuring that water that is carried along in droplet form in the fuel-cell exhaust gas upstream of the hydrogen catalyst arrangement is separated in the water separation arrangement, so that the catalyst material of the hydrogen catalyst arrangement is protected from excessive contact with water and the water content in the fuel-cell exhaust gas is already reduced when it enters the hydrogen catalyst arrangement.

Along with the lowering of the relative humidity, and consequently mitigation of the risk of mist being formed on contact with cold ambient air, in the fuel-cell exhaust system of a construction according to the disclosure there is a significant lowering of the hydrogen content in the fuel-cell exhaust gas, and consequently the amount of hydrogen emitted to the environment with the fuel-cell exhaust gas to be regarded potentially as a greenhouse gas.

In order to avoid damage to the hydrogen catalyst arrangement by overheating when for example a comparatively large amount of hydrogen is contained in the fuel-cell exhaust gas during or after carrying out a purging process, a bypass line that can be opened and closed to the flow of fuel-cell exhaust gas through it may be provided for optionally conducting at least part of the fuel-cell exhaust gas past the hydrogen catalyst arrangement.

In order to provide information that there is the potential risk of damage to the hydrogen catalyst arrangement due to an excessive amount of hydrogen in the fuel-cell exhaust gas, a hydrogen sensor for providing information representing the hydrogen content in the fuel-cell exhaust gas may be provided upstream of the hydrogen catalyst arrangement.

Alternatively or in addition, information about excessive loading or overheating of the hydrogen catalyst arrangement may be provided in that a temperature sensor for providing information representing a temperature in the area of the hydrogen catalyst arrangement is provided downstream of the hydrogen catalyst arrangement or/and in the hydrogen catalyst arrangement.

The kinetic energy contained in the fuel-cell exhaust gas stream may be used for example in that a turbine arrangement with a turbine area driven by the fuel-cell exhaust gas and a compressor area coupled to the turbine area for generating a process gas stream is provided upstream of the hydrogen catalyst arrangement and downstream of the water separation arrangement. For example, the air to be introduced as cathode gas into the cathode area of a fuel cell can be used as the process gas.

For the catalytic conversion of the hydrogen, the hydrogen catalyst arrangement may include an oxidation catalyst, for example with platinum or/and palladium as the catalyst material. In this oxidation reaction, the hydrogen is converted with oxygen into water. Although this increases the water content in the fuel-cell exhaust gas, the heat released during the catalytic conversion causes such strong heating of the fuel-cell exhaust gas that, despite the uptake of water in the fuel-cell exhaust gas generated during the catalytic conversion, the relative humidity is substantially reduced, and as a result the formation of mist on contact with comparatively cold ambient air is largely prevented.

The present disclosure also relates to a fuel cell system, in particular in a vehicle, including
at least one fuel cell with an anode area to be supplied with hydrogen-containing anode gas and a cathode area to be supplied with oxygen-containing cathode gas,
a fuel-cell exhaust system of a construction according to the disclosure, the water separation arrangement for receiving fuel-cell exhaust gas discharged at the cathode area of the at least one fuel cell being connected to the cathode area.

The object stated at the beginning is also achieved by a method for reducing the hydrogen content in fuel-cell exhaust gas produced in a fuel cell system, including the measures:
a) separating water contained in the fuel-cell exhaust gas
b) reducing the hydrogen content in the water-depleted fuel-cell exhaust gas in a catalytic reaction;
c) discharging to the environment the fuel-cell exhaust gas depleted of hydrogen and heated by measure b).

The catalytic conversion of the hydrogen contained in the fuel-cell exhaust gas releases heat by which, even if water is produced during the catalytic conversion of hydrogen contained in the fuel-cell exhaust gas with oxygen contained in the fuel-cell exhaust gas and is taken up in the fuel-cell exhaust gas, the temperature of the fuel-cell exhaust gas is raised to such an extent that its relative humidity decreases significantly and, even on contact with comparatively cold ambient air, mist formation is largely prevented, while simultaneously lowering the amount of hydrogen emitted to the environment.

In order to avoid overheating of a hydrogen catalyst arrangement used for carrying out the catalytic reaction, it is proposed that measure b) includes detecting the hydrogen content in the fuel-cell exhaust gas to be supplied to the catalytic reaction, wherein, whenever the hydrogen content in the fuel-cell exhaust gas to be supplied to the catalytic reaction is above a predetermined hydrogen content threshold, at least part of the fuel-cell exhaust gas to be supplied to the catalytic reaction is not supplied to the catalytic reaction.

Alternatively or in addition, for preventing overheating of a hydrogen catalyst arrangement used for carrying out the catalytic reaction, measure b) may include detecting a temperature of the fuel-cell exhaust gas after carrying out the catalytic reaction or/and detecting a temperature of a hydrogen catalyst arrangement used for carrying out the catalytic reaction, wherein, whenever the temperature of the fuel-cell exhaust gas or/and the temperature of the hydrogen catalyst arrangement is above a predetermined temperature threshold, at least part of the fuel-cell exhaust gas to be supplied to the catalytic reaction is not supplied to the catalytic reaction.

In order to efficiently prevent the formation of mist when the fuel-cell exhaust gas is discharged into the environment even whenever part of the fuel-cell exhaust gas or the hydrogen contained therein is not supplied to the catalytic reaction, for example due to an excessively high hydrogen content in the fuel-cell exhaust gas, it is proposed that measure b) includes merging the part of the fuel-cell exhaust gas that is not supplied to the catalytic reaction and the part of the fuel-cell exhaust gas that is supplied to the catalytic reaction after carrying out the catalytic reaction and before carrying out measure c).

The method according to the disclosure can advantageously be carried out via a fuel-cell exhaust system of a construction according to the disclosure in a fuel cell system of a construction according to the disclosure containing this exhaust system.

### BRIEF DESCRIPTION OF DRAWINGS

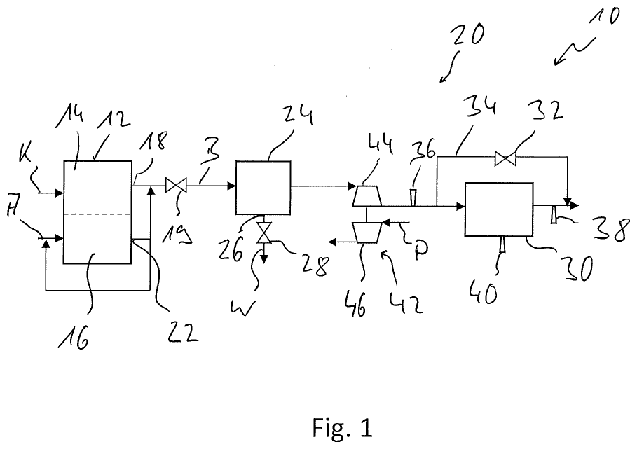

The invention will now be described with reference to the drawings wherein: FIG. 1 shows a fuel cell system with a fuel-cell exhaust system in a basic representation.

### DETAILED DESCRIPTION

In FIG. 1, a fuel cell system, provided for example for generating electrical energy in a vehicle, is denoted generally by 10. The fuel cell system 10 includes a fuel cell 12, formed for example as a fuel cell stack or the like, with a cathode area 14 and an anode area 16. The cathode area 14 is supplied with a cathode gas K containing oxygen, for example air, by a compressor or the like. An anode gas A containing hydrogen (H₂) is supplied to the anode area 16.

A cathode exhaust gas produced in the fuel cell process leaves the cathode area 14 at a cathode-area outlet area 18 and flows for example via an optionally shut-off valve 19 in the direction of a fuel-cell exhaust system denoted generally by 20. At an anode-area outlet area 22, anode exhaust gas, escaping for example when performing a purging process, can be recycled into the working process, in order to be able to use the hydrogen contained therein to generate electrical energy, or/and can be supplied together with the cathode exhaust gas as fuel-cell exhaust gas B to the fuel-cell exhaust system 20.

In fuel cell operation, water is produced, in particular in the cathode area 14, and is generally carried along as water vapor, partly also in droplet form, in the cathode exhaust gas substantially containing oxygen and nitrogen. The content of the water or water vapor in the cathode exhaust gas can be comparatively large and close to complete saturation, that is, a relative humidity of 100%. If such a cathode exhaust gas containing a high proportion of water or water vapor is emitted to the environment as fuel-cell exhaust gas B, there is the risk that water will condense out, in particular at a comparatively low ambient temperature, when the fuel-cell exhaust gas B comes into contact with the cold ambient air, and consequently mist will be produced.

In order to largely eliminate the risk of mist formation during the discharge of fuel-cell exhaust gas B in the fuel-cell exhaust system 20 shown in FIG. 1 or the fuel cell system 10 having this exhaust system, the fuel-cell exhaust system 20 includes a water separation arrangement 24, in which water W carried along in the fuel-cell exhaust gas B in liquid form, that is, for example in droplet form, is separated from the fuel-cell exhaust gas B, for example by producing a swirling flow or/and stabilizing the flow and by making use of gravitational force. In a separation-arrangement outlet area 26, which can be optionally opened and closed by an associated valve 28, the water W separated in the water separation arrangement 24 can be discharged and either emitted to the environment or fed back in the fuel cell process.

The water-depleted fuel-cell exhaust gas B leaves the water separation arrangement 24 in the direction of a hydrogen catalyst arrangement 30. The hydrogen catalyst arrangement 30 is constructed as an oxidation catalyst and may include a monolith which is constructed or coated with catalyst material, for example platinum or/and palladium, and through which the fuel-cell exhaust gas B can flow. During the catalytic reaction that takes place in the hydrogen catalyst arrangement 30, molecular hydrogen (H₂) contained in the fuel-cell exhaust gas B is converted with molecular oxygen (O₂) also contained in the fuel-cell exhaust gas B into water (H₂O), which can be discharged to the environment together with the fuel-cell exhaust gas B depleted of water in the water separation arrangement 24 and depleted of hydrogen in the hydrogen catalyst arrangement 30.

During the catalytic conversion of the hydrogen in the hydrogen catalyst arrangement 30, heat is released, which ensures that the temperature of the fuel-cell exhaust gas B leaving the hydrogen catalyst arrangement 30 is significantly raised. The increase in temperature of the fuel-cell exhaust gas B has the consequence that its water uptake capacity increases significantly, which correspondingly results in a decrease in the relative humidity of the fuel-cell exhaust gas B leaving the hydrogen catalyst arrangement 30, although this fuel-cell exhaust gas B also contains the water produced during the catalytic conversion.

Due to the significantly lowered relative humidity, the emission of this fuel-cell exhaust gas B to the environment does not have the consequence that the temperature of the fuel-cell exhaust gas B drops below the dew point even when it comes into contact with comparatively cold ambient air. Spontaneous formation of mist when the fuel-cell exhaust gas B comes into contact with the cold ambient air can thus be largely avoided. At the same time, the catalytic conversion also reduces the amount of potentially climate-harming hydrogen that is emitted to the environment.

In fuel cell operation, the hydrogen content in the fuel-cell exhaust gas B introduced into the fuel-cell exhaust system 20 may be comparatively high in phases, for example during or after carrying out purging processes. If a fuel-cell exhaust gas B containing a large amount of hydrogen is introduced into the hydrogen catalyst arrangement 30, there is the potential risk of overheating, and consequently damage to the hydrogen catalyst arrangement 30. In order to avoid this, the fuel-cell exhaust system 20 has a bypass line 34 which can be optionally closed or opened to flow through it by a valve 32. The bypass line 34 bypasses the hydrogen catalyst arrangement 30, and consequently branches off the or at least part of the fuel-cell exhaust gas B before introduction into the hydrogen catalyst arrangement 30 when the valve 32 opens the bypass line 34 to flow through it.

Provided upstream of the hydrogen catalyst arrangement 30, for example in the direction of flow between the water separation arrangement 24 and the hydrogen catalyst arrangement 30, is a hydrogen sensor 36, which detects the hydrogen concentration or the amount of hydrogen in the fuel-cell exhaust gas B or provides information representing this variable. Depending on the information representing the hydrogen concentration or the hydrogen content in the fuel-cell exhaust gas B, the valve 32 may be activated to close the bypass line 34 if the information representing the hydrogen concentration or the hydrogen content and supplied by the hydrogen sensor 36 indicates a hydrogen content below a hydrogen content threshold that does not lead to overheating of the hydrogen catalyst arrangement 30 when carrying out the catalytic reaction. If the information generated by the hydrogen sensor 36 indicates an excessively large hydrogen content or an excessively high hydrogen concentration in the fuel-cell exhaust gas B, the valve 32 may be activated to open the bypass line 34 at least partially, so that, for example also depending on the hydrogen content in the fuel-cell exhaust gas B, part of the fuel-cell exhaust gas B is conducted past the hydrogen catalyst arrangement 30. This part of the fuel-cell exhaust gas B is merged downstream of the hydrogen catalyst arrangement 30 with the hydrogen-depleted and heated part of the fuel-cell exhaust gas B leaving the hydrogen catalyst arrangement 30, so that the overall flow of the fuel-cell exhaust gas B leaving the fuel-cell exhaust system 20 also has a raised temperature, and therefore the formation of mist on contact with comparatively cold ambient temperature can be counteracted.

Alternatively or in addition to providing the information representing the hydrogen content in the fuel-cell exhaust gas B by the hydrogen sensor 36, information representing the temperature of the fuel-cell exhaust gas B downstream of the hydrogen catalyst arrangement 30 can be provided by a temperature sensor 38. The temperature of the fuel-cell exhaust gas B at the outlet of the hydrogen catalyst arrangement 30 is an indicator of the extent of the catalytic reaction occurring in the hydrogen catalyst arrangement 30. If this temperature is above a temperature threshold, this is an indicator that an excessively strong catalytic reaction is occurring in the hydrogen catalyst arrangement 30 and there is the risk of overheating. For the purpose of lowering the temperature of the hydrogen catalyst arrangement 30, this information may also be used to conduct part of the fuel-cell exhaust gas B, and consequently also part of the hydrogen contained therein, via the bypass line 34 past the fuel-cell exhaust system 30 and to merge this part of the fuel-cell exhaust gas B before discharge to the environment with the part of the fuel-cell exhaust gas B conducted through the hydrogen catalyst arrangement 30.

Alternatively or in addition, it is also possible to detect the temperature of the hydrogen catalyst arrangement 30, for example at the surface of the catalytic material thereof, directly via a temperature sensor 40 and to use this temperature as an indicator of whether an excess of hydrogen is introduced into the hydrogen catalyst arrangement 30 and, in order to avoid overheating, part of the fuel-cell exhaust gas B should be conducted past the hydrogen catalyst arrangement 30 via the bypass line 34.

By providing information which can be used to avoid overheating of the hydrogen catalyst arrangement 30 when there is excessive hydrogen content in the fuel-cell exhaust gas B, it becomes possible to dimension the hydrogen catalyst arrangement 30 in such a way that in normal fuel cell operation, in which the fuel-cell exhaust gas B contains a comparatively small amount of hydrogen, it provides sufficient capacity for the catalytic conversion of this hydrogen, but is not oversized. For operating states in which an excessively large amount of hydrogen is emitted from the fuel cell 12, a hydrogen catalyst arrangement 30 of such dimensions would be undersized. Nevertheless, overloading such a potentially undersized hydrogen catalyst arrangement 30 can also be avoided in states in which the fuel-cell exhaust gas B has an excessively great concentration of hydrogen by conducting part of the fuel-cell exhaust gas through the bypass line 34.

The fuel-cell exhaust system 20 shown in FIG. 1 also contains for example in the direction of flow between the water separation unit 24 and the hydrogen catalyst arrangement 30 a turbine arrangement denoted generally by 42. The turbine arrangement 42 is constructed in principle in the manner of a turbocharger used in exhaust systems of internal combustion engines and includes a turbine area 44 driven by the fuel-cell exhaust gas B flowing in the fuel-cell exhaust system 20 and a compressor area 46 coupled to the turbine area 44 or driven by it. The kinetic energy contained in the fuel-cell exhaust gas B can consequently be partially used to generate a stream of a process gas P via the turbine arrangement 42. For example, the process gas P may include the or at least part of the cathode gas K to be introduced into the cathode area 14 of the fuel cell 12.

It should be noted that the fuel-cell exhaust system includes further system areas, such as for example a silencer or the like, for example downstream of the hydrogen catalyst arrangement 30, so that the fuel-cell exhaust gas B is not discharged from the hydrogen catalyst arrangement to the environment directly, but via such further system areas.

It is understood that the foregoing description is that of the preferred embodiments of the invention and that various changes and modifications may be made thereto without departing from the spirit and scope of the invention as defined in the appended claims.

1. A fuel-cell exhaust system for a fuel cell system, the fuel-cell exhaust system comprising:
a water separation arrangement for separating water contained in fuel-cell exhaust gas; and,
a hydrogen catalyst arrangement for catalytically converting hydrogen contained in the fuel-cell exhaust gas downstream of said water separation arrangement.

2. The fuel-cell exhaust system of claim 1, further comprising a bypass line that can be opened and closed to the flow of fuel-cell exhaust gas therethrough being provided for optionally conducting at least part of the fuel-cell exhaust gas past said hydrogen catalyst arrangement.

3. The fuel-cell exhaust system of claim 1, further comprising a hydrogen sensor for providing information representing the hydrogen content in the fuel-cell exhaust gas being provided upstream of said hydrogen catalyst arrangement.

4. The fuel-cell exhaust system of claim 1, further comprising a temperature sensor for providing information representing a temperature in the area of said hydrogen catalyst arrangement being provided in accordance with at least one of the following:
i) downstream of the hydrogen catalyst arrangement; and,
ii) in the hydrogen catalyst arrangement.

5. The fuel-cell exhaust system of claim 1, further comprising a turbine arrangement having a turbine area driven by the fuel-cell exhaust gas and a compressor area coupled to the turbine area for generating a process gas stream is provided upstream of said hydrogen catalyst arrangement and downstream of said water separation arrangement.

6. The fuel-cell exhaust system of claim 1, wherein said hydrogen catalyst arrangement includes an oxidation catalyst.

7. A fuel cell system comprising:
at least one fuel cell having an anode area to be supplied with hydrogen-containing anode gas and a cathode area to be supplied with oxygen-containing cathode gas; and,
a fuel-cell exhaust system including:
a water separation arrangement for separating water contained in fuel-cell exhaust gas; and,
a hydrogen catalyst arrangement for catalytically converting hydrogen contained in the fuel-cell exhaust gas downstream of said water separation arrangement; and,
said water separation arrangement for receiving fuel-cell exhaust gas discharged at said cathode area of said at least one fuel cell being connected to said cathode area.

8. A method for reducing the hydrogen content in fuel-cell exhaust gas produced in a fuel cell system, the method comprising the steps of:
a) separating water contained in the fuel-cell exhaust gas;
b) reducing the hydrogen content in the water-depleted fuel-cell exhaust gas in a catalytic reaction; and,
c) discharging to the environment the fuel-cell exhaust gas depleted of hydrogen and heated by step b).

9. The method of claim 8, wherein step b) comprises detecting a hydrogen content in the fuel-cell exhaust gas to be supplied to the catalytic reaction; and, wherein, whenever the hydrogen content in the fuel-cell exhaust gas to be supplied to the catalytic reaction is above a predetermined hydrogen content threshold, at least part of the fuel-cell exhaust gas to be supplied to the catalytic reaction is not supplied to the catalytic reaction.

10. The method of claim 8, wherein step b) comprises at least one of the following:
i) detecting a temperature of the fuel-cell exhaust gas after carrying out the catalytic reaction; and
ii) detecting a temperature of a hydrogen catalyst arrangement used for carrying out the catalytic reaction;
wherein, at least one of the following applies:
i) whenever the temperature of the fuel-cell exhaust gas is above a predetermined temperature threshold, and,
ii) whenever the temperature of the hydrogen catalyst arrangement is above a predetermined temperature threshold,
then at least part of the fuel-cell exhaust gas to be supplied to the catalytic reaction is not supplied to the catalytic reaction.

11. The method of claim 10, wherein step b) comprises merging the part of the fuel-cell exhaust gas that is not supplied to the catalytic reaction and the part of the fuel-cell exhaust gas that is supplied to the catalytic reaction after carrying out the catalytic reaction and before carrying out step c).

12. The method of claim 8, wherein the method is carried out by a fuel-cell exhaust system in a fuel cell system:
wherein the fuel-cell exhaust system includes a water separation arrangement for separating water contained in fuel-cell exhaust gas, and a hydrogen catalyst arrangement for catalytically converting hydrogen contained in the fuel-cell exhaust gas downstream of said water separation arrangement; and, the fuel cell system includes at least one fuel cell having an anode area to be supplied with hydrogen-containing anode gas and a cathode area to be supplied with oxygen-containing cathode gas.

13. The fuel-cell exhaust system of claim 1, wherein said fuel cell system is for a vehicle.

14. The fuel cell system of claim 7, wherein the fuel cell system is for a vehicle.
